(19) United States
(12) Patent Application Publication
(10) Pub. No.: US 2006/0151236 A1
(43) Pub. Date: Jul. 13, 2006

(54) Enhancing audio reinforcement systems and methods

(76) Inventor: Patrick J. McCool, Huntsville, AL (US)

Correspondence Address: LANIER FORD SHAVER & PAYNE, P O BOX 2087, HUNTSVILLE, AL, 35804, US

(21) Appl. No.: 11/326,751

(22) Filed: Jan. 6, 2006

Related U.S. Application Data
(60) Provisional application No. 60/642,409, filed on Jan. 7, 2005.

(51) Int. Cl. H04R 25/00

(52) U.S. Cl. 181/129

(57) ABSTRACT

A system and method for an enhancing audio reinforcement system is claimed. The system provides a device comfortably mountable to the human head and consisting of a headband and at least one reflector that simulates a cupped hand over a listener's ear. The system is used to enhance the wearer's listening ability and pleasure by concentrating desired sounds into the ears and blocking transmission of side and background noise. The invention also is intended to contact the bony structure of the human skull and jaw line and to induce sound vibrations therein.

### REFERENCE TO RELATED APPLICATIONS

This application claims priority to Provisional Patent Application U.S. Ser. No. 60/642,409, entitled “Enhancing Audio Reinforcement System and Method” and filed on Jan. 7, 2005, which is fully incorporated herein by reference.

### BACKGROUND

1. Field of the Invention

The present invention relates generally to a hearing augmentation device and method, and more specifically to a device mountable to the human head and including a pair of human-hand-shaped reflectors adapted to concentrate, direct and deflect audible signals and sound waves into the ears in the manner of a pair of human hands cupped behind the ears.

2. Background of the Invention

The invention is intended to enhance the listening experience of individuals at events such as concerts, the theater, or lectures to block out background noises and concentrate the desired sounds and direct them into the ears. Most people at one time or another have cupped their hands over their ears in order to hear better, and the human hands are ideally shaped for this purpose. Inventions in the past have used cup- or shell-shaped devices to direct sound waves into the ears (U.S. Pat. Nos. 698,713 and 4,997,056, for example). But none of the prior art inventions have utilized the precise shape of the human hand, which provides a more natural and comfortable listening experience.

In addition to concentrating and directing sound waves into the ears, the invention's close contact with the human jaw and head induces vibrations in the human body which enhance the listening experience. The present invention also causes a gentle forward bending of the user's ears to further increase hearing ability. Use of the invention increases the clarity and fidelity of music. In addition to use at live performances or theaters, the invention is ideal for home stereo use.

### SUMMARY OF THE INVENTION

Therefore, the primary objective of this invention is to provide an acoustic device that mechanically receives a greater amount of sound waves than can the human ear alone, while simulating the human hand cupped behind the ear in such a way that the invention closely contacts the ear, as well as the human head and jaw. Another object of the present invention is to provide such a device that is lightweight and readily and comfortably mountable on a person's head. Another object of the present invention is to provide a device that is usable indoors or in outdoor weather conditions. Another object of the present invention is to provide an acoustical hearing aid device which employs no electrical or electronic circuit components. Another object of the present invention is to provide a method for blocking or inhibiting un-desirable sounds emanating from beside and behind the wearer of the invention (such as crowd noise), while concentrating desirable sounds coming from the front of the wearer.

The present invention achieves these objects by providing a comfortable headband outfitted with one or more reflectors formed in the shape and size of a cupped human hand. The reflectors fit behind the ears and amplify sounds emanating from the front of the listener by focusing and propagating desired audible sound waves to the ears while reducing undesirable background noises. The reflectors also contact the bones of the face and jaw to induce sound vibrations therein. The device can be worn by listeners in opera houses, auditoriums, amphitheatres, classrooms, or in any environment where improved sound amplification is desired.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements.

FIG. 1 is a front view of one embodiment of the invention;

FIG. 2 is a side view of one embodiment of the invention;

FIG. 3 is a front view of one embodiment of the invention worn by a listener;

FIG. 4 is a side view of one embodiment of the invention worn by a listener;

FIG. 5 illustrates the inner surface of one of the reflectors.

### DETAILED DESCRIPTION OF THE ILLUSTRATED EMBODIMENT

The present invention and its advantages are best understood by referring to the drawings. The elements of the drawings are not necessarily to scale, emphasis instead being placed upon clearly illustrating the principles of the invention.

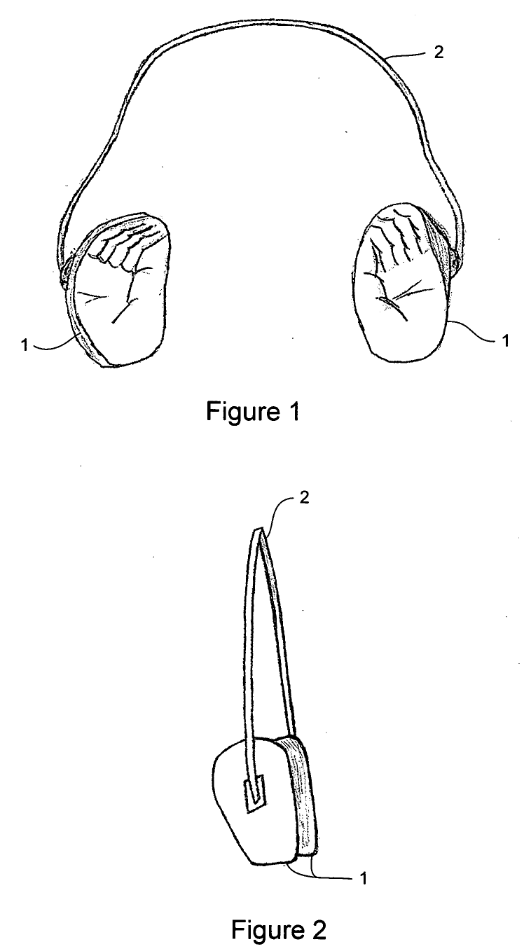

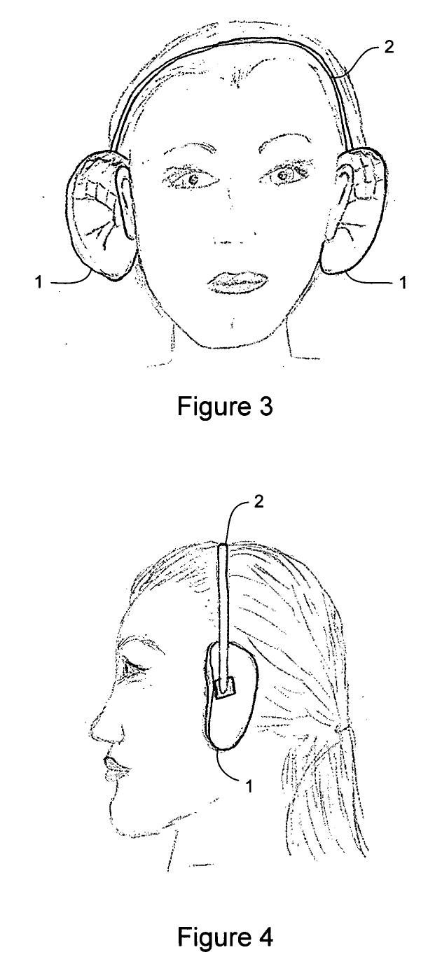

FIGS. 1 and 2 illustrate one embodiment of the invention. In this embodiment, a pair of hand-shaped reflectors 1 simulates the inner portion of a pair of cupped human hands, and a headband 2 is used to secure the reflectors to the wearer's head with the reflectors opened in a forward-facing direction. FIG. 3 shows a frontal view of one embodiment of the invention worn by a user, and FIG. 4 shows a side view of the invention worn by a user.

The headband 2 is a resilient headband section of inverted substantially U-shaped form adapted to comfortably attach over the top of a person's head, the resilient headband extending across the top of the wearer's head and terminating adjacent an upper portion of each of the wearer's ears. As can be seen in the illustrations, each acoustic reflector 1 is mounted to the headband 2 in such a manner that the open half of the reflector faces to the front of the user. This shape forms a reflector that reflects sound waves from a frontal sound source onto the central portion of the external ear that best serves to reflect sound into the opening of the ear canal. The base of the reflector 1 surrounds the outer rear of the ear for amplification of sound sources to the user's front.

The reflector 1 can be made of any of a number of sound-reflective materials (such as plastic, rubber, or a composite material) and act as acoustic sound collectors which serve to collect and focus the sound waves emanating from sources directly in front of the user. Sound waves which emanate from sources directly in front of the user will strike inner surfaces of the reflector and then be reflected into the user's ear canals.

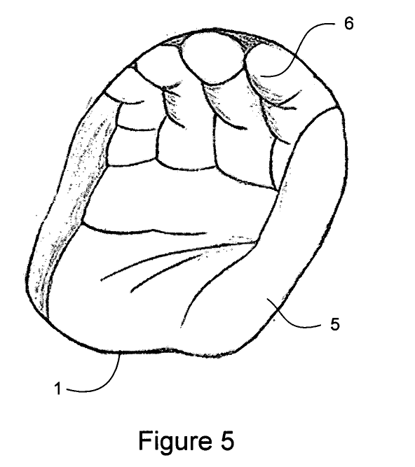

FIG. 5 is an enlarged frontal view of one embodiment of the reflector 1. As can be seen in this figure, the inner surface of the reflector 1 is contoured to represent the inner surface of a cupped human hand. In this embodiment, a bone contact portion 5 of the reflector 1 contacts the wearer's head and jaw line, in the same way that the edge of a cupped hand does when a hand is cupped around an ear. This bone contact portion 5 of the reflector 1 is intended to induce sound vibrations in the listener's head and jaw, thus intensifying the listening experience. A forwardly-bent top portion 6 of the reflector 1 can also serve to gently bend the pinna, or outside edges of the listener's ear, forward in the same manner as a cupped hand behind an ear, which increases sound transmission. In other embodiments of the invention, the reflectors 1 may include the full three-dimensional shape of the hands (i.e. contains both the tops and bottoms of the hands).

The basic principle of using collectors for collecting and focusing sound waves into a user's ear canals, and thereby magnifying their amplitude as heard by the user, is well known. However, the reflectors of the present invention have a novel structure and shape and provide advantages not seen in the prior art. Because the shape and size of a reflector approximates those of a cupped human hand, some embodiments of the present acoustic reflectors are thicker than most existing designs of acoustic reflectors. The thickness of the reflectors effectively minimizes transmission of sound waves through the reflectors.

The headband 2 is adjustable in length and to permit maximum accommodation of the device to the size and shape of the user's head, for greater comfort and effectiveness. The headband 2 can be made of a variety of materials, such as plastic, composite materials, or metals.

This invention may be provided in other specific forms and embodiments without departing from the essential characteristics as described herein. The embodiment described is to be considered in all aspects as illustrative only and not restrictive in any manner. The following claims rather than the foregoing description indicate the scope of the invention.

As described above and shown in the associated drawings and exhibits, the present invention comprises a method and system for an enhancing audio reinforcement system. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. An improved listening device comprising at least one reflector, the reflector being larger than a human ear and sized and ridged to simulate the interior surfaces of a cupped human hand.

2. The improved listening device of claim 1, further comprising a headband adapted to fit on a listener's head, the at least one reflector being secured to the headband so that the headband is positionable on the listener's head with the at least one reflector extending transversely outward of the head and behind at least one of the listener's ears and positioned to reflect forwardly-incoming sound waves toward at least one of the listener's ears.

3. The improved listening device of claim 2, wherein the head band is adjustable to fit on various size heads.

4. The improved listening device of claim 2, wherein the headband is a substantially U-shaped headband section having two ends positionable adjacent the listener's ears.

5. The improved listening device of claim 1, wherein the reflector further comprises a bone contact section adapted to press against the skin of a listener adjacent to an ear so that the reflector induces sound vibrations onto the bones adjacent to the listener's ears.

6. The improved listening device of claim 1, wherein the reflector further comprises a forwardly-bent top portion adapted to gently bend the listener's pinna forward.

7. The improved listening device of claim 1, wherein the reflector further simulates the exterior surfaces of a cupped human hand.

8. An improved listening device comprising
at least one reflector,
the reflector being larger than a human ear and sized and ridged to simulate the interior surfaces of a cupped human hand;
the reflector further reflector comprising a bone contact section adapted to press against the skin of a listener adjacent to an ear so that the reflector induces sound vibrations onto the bones adjacent to the listener's ears;
the reflector further comprising a forwardly-bent top portion adapted to gently bend the listener's pinna forward;
a headband adapted to fit adjustably on a listener's head, the at least one reflector being secured to the headband so that the headband is positionable on the listener's head with the at least one reflector extending transversely outward of the head and behind at least one of the listener's ears and positioned to reflect forwardly-incoming sound waves toward at least one of the listener's ears.

9. A method for enhancing a listener's ability to hear sounds, comprising the steps of:
a. donning a headband to which is attached one or more reflectors, wherein each reflector is sized and ridged to simulate the interior surfaces of a cupped hand;
b. adjusting the headband that secures the reflectors so that each reflector is fixed behind one or more of the listener's ears positioned so as to reflect forwardly-incoming sound waves toward the ears.
